(19) United States
(12) Patent Application Publication
(10) Pub. No.: US 2008/0198011 A1
(43) Pub. Date: Aug. 21, 2008

(54) RADIO-FREQUENCY IDENTIFICATION TAGS FOR PREVENTING AND DETECTING TAMPERING

(76) Inventor: John Anthony Leper, Santa Monica, CA (US)

Correspondence Address: BAKER & MCKENZIE LLP, Pennzoil Place, South Tower, 711 Louisiana, Suite 3400, HOUSTON, TX, 77002-2716, US

(21) Appl. No.: 11/755,333

(22) Filed: May 30, 2007

Related U.S. Application Data
(60) Provisional application No. 60/901,675, filed on Feb. 16, 2007.

(51) Int. Cl. G08B 13/14

(52) U.S. Cl. 340/572.1

(57) ABSTRACT

The current invention discloses a radio-frequency identification (RFID) tag based system that is capable of detecting tampering of a genuine goods. The system comprises an RFID tag, an end node, and a tentacle that electrically connects the RFID tag with the end node. An attempt to remove the RFID tag would cause the tentacle to break so that the electrical/electronic communication between the RFID tag and the end node is disrupted, therefore indicating that the goods has been tampered with.

### PRIOR RELATED APPLICATIONS

The current application claims the priority of U.S. provisional patent application with Ser. No. 60/901,675, filed on Feb. 16, 2007, titled Tags for Preventing and Detecting Tampering.

### FEDERALLY SPONSORED RESEARCH STATEMENT

Not applicable.

### REFERENCE TO MICROFICHE APPENDIX

Not applicable.

### FIELD OF THE INVENTION

Embodiments of the invention are generally related to the field of using radio-frequency identification (RFID) tags for preventing and detecting tampering of goods.

### BACKGROUND OF THE INVENTION

Radio-frequency identification (RFID) tags are chip-based devices that are capable of storing electronic information and emitting wireless signals to a remotely located data retrieving device (i.e. a “reader”). Most RFID tags are based on silicon chips, and generally each tag contains two elements: a silicon chip that stores data and an antenna that transmits the data to a reader. However, non-silicon chip based RFID tags are also available. For example, some systems use chemical particles having different degrees of magnetism. Some other systems use magnetic inks or polymer semiconductors to “print” RFID tags. They all share the same fundamental characteristics: being able to transmit data to a reader via radio frequencies.

Depending on whether an internal power supply is present inside a tag, RFID tags can be generally divided into 2 categories: active and passive. An active RFID tag is equipped with an internal power supply, often a battery, which powers the integrated circuit of the RFID tag to generate signals and transmit signals to the reader. Depending on the size of the battery and the design of the antenna, signals can be transmitted for several meters or even several hundred meters. A popular example of active RFID tags is the highway toll collection device used in several areas of the United States and other countries around the world, such as SunPass in Florida, E-ZPass in New York, E-Toll in Australia, Telepass in Italy, just to name a few. The battery life for such devices can be up to 10 years.

A passive RFID tag does not contain an internal power supply. It acquires power from the radio frequency of an approaching reader. The tag then uses the power to generate a reply signal, propagate the signal to the antenna, and transmit the signal back to the reader. In this respect, the data retrieving process of a passive RFID tag is also called a “charging” process—the reader “charges” the passive RFID tag and powers the tag to operate. Because passive RFID tags do not contain internal power supplies, they tend to be smaller in size compared with active RFID tags.

RFID tags (both active and passive) have been used to replace traditional barcodes for identifying goods and tracking inventories. One advantage of using RFID tags to replace traditional barcodes is that RFID tags use radio frequencies instead of light reflections. Therefore, RFID tags can be placed inside of products and hidden at locations that cannot be easily observed from the outside of the products. As such, RFID tags have been used as anti-counterfeiting and inventory tracking devices in several industries, especially by pharmaceutical companies and luxury goods manufacturers due to the high occurrence of counterfeiting products on the market.

However, currently available RFID tags lack tampering-prevention functionality. Thus, a counterfeiter may obtain a genuine product, remove the RFID tag, and re-apply it to a counterfeiting product. For medicines that are packaged in bottles, it is also possible for a counterfeiter to empty the genuine content of a bottle and refill the bottle with fake medicines.

Consequently, there is a need for a RFID tags that detect and prevent tampering with genuine products.

### DESCRIPTION OF EMBODIMENTS OF THE INVENTION

According to one aspect of the current invention, a system is provided that is capable of detecting tampering with genuine goods. In one embodiment, the system comprises a radio-frequency identification (RFID) tag, an end node, and a tentacle that electrically connects the RFID tag with the end node. Any attempt to remove the RFID tag will cause the tentacle to break so that electric communication between the RFID tag and the end node would be disrupted, thus alerting the user to tampering.

According to another aspect of the invention, there is provided a system comprises a radio-frequency identification (RFID) tag and an electrically conductive tentacle, wherein the tentacle forms a closed circuit with the RFID tag so that breakage of the tentacle indicates the goods has been tampered with.

According to an additional aspect of the current invention, there is provided a system wherein more than one tentacle and/or more than one end node are connected to an RFID tag. The multiple tentacles and/or end nodes can be hidden at multiple places of one product, therefore providing the product with all-around protection. Alternatively, the multiple tentacles/end nodes can be positioned in multiple products, therefore the multiple products can be tracked by a single, integrated system.

### BRIEF DESCRIPTION OF THE DRAWINGS

FIG. 1 illustrates a system in accordance with one embodiment of the current invention;

FIG. 2 comprises a series of diagrams illustrating various applications of the current invention;

FIG. 3 illustrates another embodiment of the current invention, wherein a tampering detecting device is affixed to the opening juncture of a bottle; and

FIG. 4 shows a further embodiment where multiple products are tracked by a system of the current invention.

### DETAILED DESCRIPTION OF EMBODIMENTS OF THE INVENTION

The following description illustrates embodiments of the invention by way of example and not by way of limitation. Thus, the embodiments described below represent preferred embodiments of the invention.

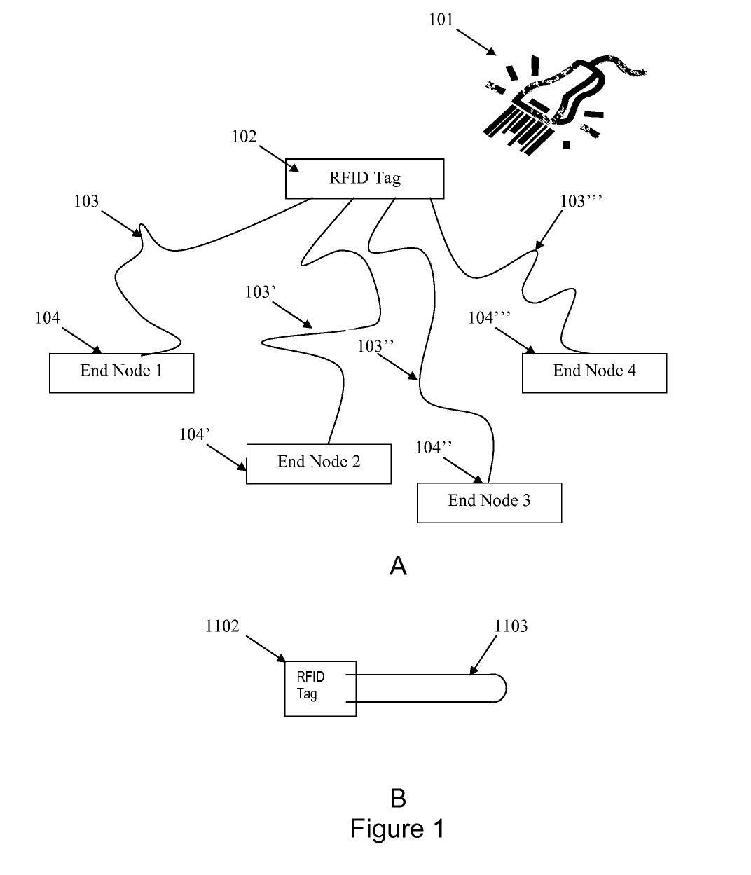

FIG. 1 illustrates one aspect of the current invention. In FIG. 1A, an RFID tag 102 is electrically connected by a tentacle 103 to an end node 104, so that electric signals can travel along the tentacle 103 from the RFID tag 102 to the end node 104, and vice versa.

The RFID tag 102 in FIG. 1A can be either passive or active, and it can be either a silicon chip based or a non-silicon chip based RFID tag. Taking a passive chip-based RFID tag as an example, when an RFID reader 101 approaches the RFID tag 102, radio frequencies emitted by the RFID reader 101 are taken up by the RFID tag 102 and the tag becomes “charged”. The “charged” RFID tag 102 then performs two actions. First, it transmits the identification information stored in the RFID tag 102 back to the reader 101. The information can be displayed on an LED screen of the reader 101 or on a computer screen connected to the reader 101. In this respect, the RFID tag 102 functions similarly to the traditional RFID tag.

Second, because the RFID tag 102 is also connected to the end node 104 via the electrically conductive tentacle 103, the “charged” RFID tag 102 further communicates with the end node 104 via the tentacle 103. If the tag 102 and the end node 104 are properly connected via the tentacle 103, a successful communication will occur. If, however, the connection between the RFID tag 102 and the end node 104 is broken, either because the tentacle itself is broken or the connection between the tentacle 103 and RFID tag 102 (or end node 104) is broken, an error message will occur. The error message is then transmitted to the reader 101 for display. The error message indicates that the goods are likely to have been tampered with.

The total number of end nodes in a system can vary depending on the intended use of the system. As illustrated in FIG. 1A, a total of four end nodes 104, 104′, 104″ and 104′″ are electrically connected to the RFID tag 102 via four tentacles 103, 103′, 103″ and 103′″, respectively. When the RFID tag 102 is charged by the reader 101, the tag 102 further charges the four end nodes 104, 104′, 104″ and 104′″ and polls the status information of the four end nodes. If all end nodes respond normally to the RFID Tag 102, it demonstrates that none of the end nodes have been tampered with and therefore the system functions properly. If, however, some or all of the end nodes 104, 104′, 104″ and 104′″ do not respond properly to the RFID Tag 102, the goods is likely to have been tampered with.

The tentacle 103 can be made of any conductive material. For example, copper, silver, gold, or their mixtures are suitable for making tentacles. Different alloys can also be used to make tentacles. The tentacle 103 can be in the form of fine threads. In some other embodiments, the tentacle 103 is in the form of printed metallic inks on paper, plastic or other materials. Preferably, the tentacle 103 is strong enough to sustain the normal wear and tear of the intended use of the goods, yet is fragile enough so that an attempt to remove the RFID tag 102 from the product will result in the breaking of the tentacle 103 or its connection to the RFID tag or end node.

The end node 104 can be any material or device capable of sending a message or a signal to the RFID tag 102 so that the tag 102 can recognize the status of the end node and/or tentacle state (broken or not broken) 104. For example, the end node 104 can be any material capable of reflecting a portion of the tag's signal back as a unique signal; the unique return signal can be used as an identifier of the node. When it is electrically connected to the tentacle 103, which in turn is electrically connected to the RFID tag 102, the unique return signal can be sent from the end node 104 to the tag 102. If, however, the connection between the end node 104 and the RFID tag 102 is broken, no unique signal will be sent from the end node 104 to the tag 102.

Alternatively, the end node 104 can be a memory storage device or material that is capable of storing at least one bit of data. According to one embodiment of the current invention, the information stored in the end node 104 is a unique ID code that can be recognized by the corresponding RFID tag 102. If the ID code from the end node 104 does not match with the information stored in the RFID tag 102, or the end node 104 does not send back an ID code at all, an error message will occur.

The end node 104 can be further configured to exchange data packet with the RFID tag 102. For example, a standard data packet with a header/data/end-checksum format can be used to effectuate the communication/verification between the RFID tag 102 and end node 104. The data embedded in the packet can be as simple as a tentacle ID code, or it may comprise a tentacle ID code and certain additional data. In some embodiments, each tentacle node is designed to hold unique data known only to the end node, not to the RFID tag, until the node is polled by the tag for status check. In some other embodiments, the end node 104 itself is an RFID tag. The end node RFID tag 104 can store ID code on its chip, transmit ID code to a reader, and communicate with the main RFID tag 102. The end node RFID tag 104 can be further connected to tentacles or other end nodes/tags. As people skilled in the art can appreciate, as the application of the current invention becomes more advanced and complicated, more sophisticated communication patterns can be adopted.

In some embodiments, the end node 104 can be a “virtual node”, as illustrated in FIG. 1B of the invention. Here, instead of having one end of a tentacle connected to an RFID tag and the other end connected to an end node, in a “virtual node”, both ends of a tentacle 1103 are connects to an RFID tag 1102, therefore forming a closed circuit between the RFID tag 1102 and tentacle 1103. In this configuration, a separate and stand-alone end node is not required. The signal is sent from the RFID tag 1102, via the tentacle 1103, and received by the same RFID tag 1102. If no signal is received by the node, the chip detects a broken tentacle.

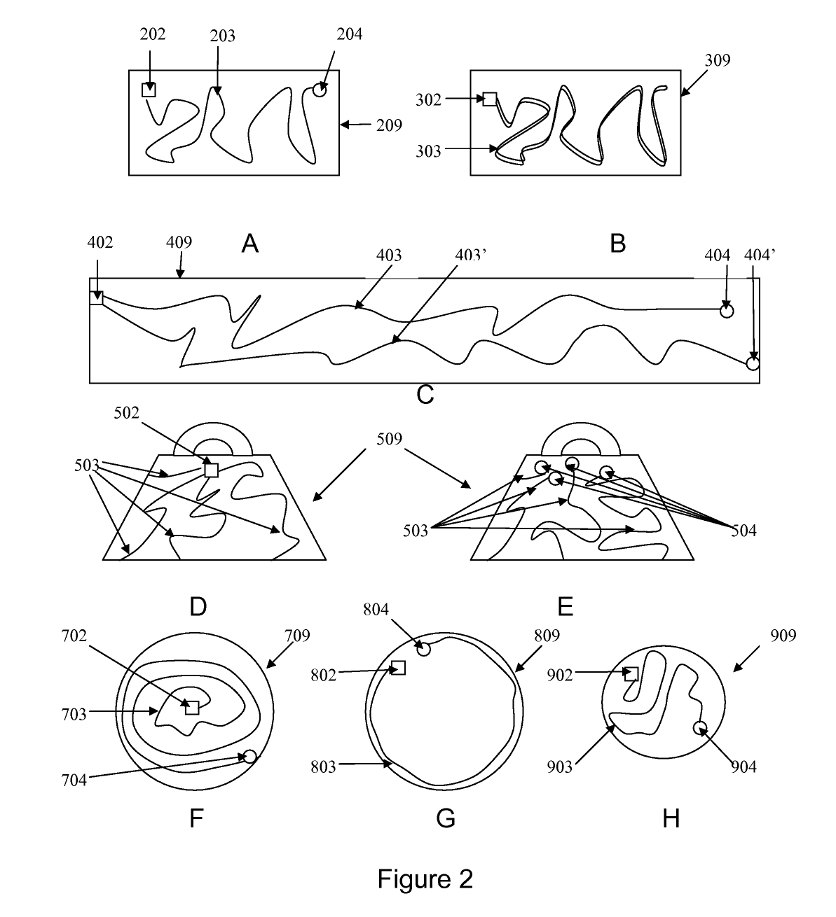

FIG. 2 illustrates various applications of the current invention. In FIG. 2A, a packaging content form 209 is depicted, which comprises a single RFID tag 202 and a single end node 204 that are connected by a single tentacle 203. The packaging content form 209 can be inserted into a package that is to be shipped by a courier. In one embodiment, the packaging content form 209 can be affixed to the surface of the package so that any attempts to remove the form 209 from the package will risk breaking the tentacle 203 embedded therein. In another embodiment, the packaging content form 209 is affixed to an opening juncture of the shipping package. If the package had been opened, the packaging content form 209 would have been cut through and the tentacle 203 would have been broken.

FIG. 2B illustrates a form 309 that is similar to the packaging content form 209 of FIG. 2A. Here, a “virtual node” configuration is employed—an RFID tag 302 is connected to a tentacle 303, which makes a closed circuit with the tag 302. No actual “end node” exists in this configuration.

FIG. 2C shows a tape or label 409 in an elongated shape. The tape or label 409 is particularly useful for sealing up the openings or edges of a courier package. As shown in FIG. 2C, a single RFID tag 402 can be connected to two end nodes 404 and 404′ by two tentacles 403 and 403′, respectively. The double-tentacle configuration provides an extra level of security to the package.

FIG. 2D and FIG. 2E are directed to the use of the current invention in luxury goods such as handbags. FIG. 2D is a front view of a handbag 509 and FIG. 2E is a back view of the same handbag. An RFID tag 502 is installed in the handbag 509, either on the surface of the handbag or hidden inside a layer of the handbag's materials. A plurality of end nodes 504 are placed at different locations of the handbag 509 and are connected to the RFID tag 502 via a plurality of tentacles 503, respectively. The end nodes 504 and the tentacles 503 can be either hidden inside the handbag or exposed on the surfaces of the handbag. Preferably, the multiple tentacles 503 and end nodes 504 are evenly distributed around the handbag to provide all-around protections to the handbag. In an even more preferred embodiment, the tentacles 503 are woven into the materials of the handbag so that it is very difficult or even impossible to remove the tentacles 503 without breaking or damaging the tentacles 503. It is important to note that a system of such embodiment not only serves the purpose of identifying the genuineness of the product for the life of the product, but also facilitates the product authentication process during the 2^{nd} hand trading of luxury goods, either on the internet or in stores.

FIGS. 2F, 2G and 2H illustrate another potential use of the current invention in the luxury goods industry. FIG. 2F shows the back view of a watch 709, where an RFID tag 702 is connected to an end node 704 via a tentacle 703. The RFID tag 702, the tentacle 703, and the end node 704 can be positioned at different locations of the watch so that any tampering of the watch would break the tentacle 703 or the connections. Similarly, in FIG. 2G, a front view of a watch 809 is shown. An RFID tag 802 can be positioned on the front surface of the watch, an end node 804 can be positioned on a different side of a front opening of the watch, and the RFID tag 802 and the end node 804 are connected via a circular tentacle 803. In FIG. 2H, the internal structure 909 of a watch is equipped with a tamper-detecting system of the current invention. An RFID tag 902 is connected to an end node 904 via a tentacle 903. The RFID tag 902 can be positioned on the movement of the watch and the end node 904 can be positioned on a gearbox of the watch, so that an attempt to remove the expensive genuine movement of the watch would break the tentacle 903 or the connections.

The RFID systems of FIGS. 2F, 2G and 2H can be combined together to provide a single watch with multiple tamper-detecting mechanisms. The multi-level protection is particularly desirable for luxury goods such as watches that are expensive and can be easily tampered with.

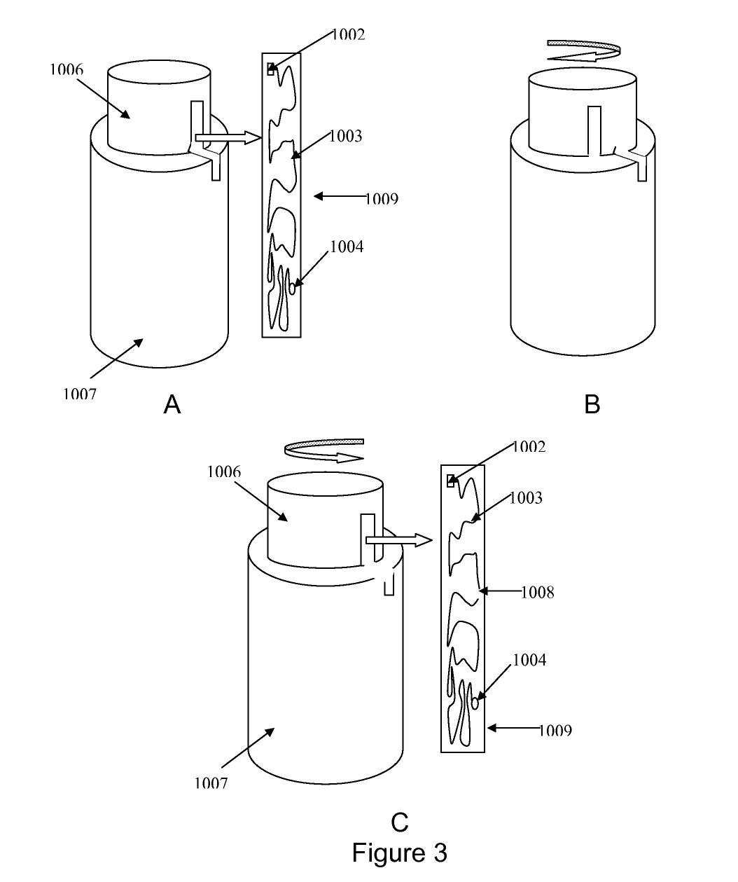

FIG. 3 shows another embodiment of the current invention. Here, a bottle with a lid 1006 and a body 1007 is provided with a tamper-detecting label 1009. Three elements are embedded in the label 1009: an RFID tag 1002, an end node 1004, and a tentacle 1003 that connects the RFID tag 1002 and the end node 1004. The label 1009 spans the opening juncture of the bottle—one end of the label 1009 is affixed to the lid 1006 of the bottle and the other end of the label 1009 is affixed to the body 1007 of the bottle. Therefore, if a counterfeiter tries to open the bottle by turning the lid 1006, as shown in FIG. 3B, the tentacle 1003 breaks and the RFID tag 1002 can no longer communicate with the end node 1004. Consequently, an error message will occur.

The label 1009 of FIG. 3 is also useful in tracking inventories. For example, when a box containing multiple bottles of a product is put into transportation, some bottle lids may accidentally become loose. Such bottles should be removed and/or repackaged immediately. Without the current invention, people would have to place a traditional RFID tag over the bottle opening, so that an accidental opening of the bottle would damage the RFID tag. This arrangement works under certain circumstances, but not always. An RFID tag may malfunction, so that even if the lid is still intact and has not been tampered with, a “no signal” can still be produced by a traditional RFID tag. Consequently, “no signal” from the traditional RFID tag does not tell a reader whether the “no signal” is caused by the opening of the bottle or is merely a result of a tag malfunctioning.

With the tamper-detecting tag of the current invention, one can now distinguish between the two scenarios. If a bottle has been opened, a tentacle is broken and no status information can be polled by the RFID tag. However, because the RFID tag itself remains intact, the traditional ID information stored in the tag can still be read out by the reader. The combination of “no signal” from the tentacle/end node and the “ID data” from the RFID tag will tell a reader that the bottle has been opened and the RFID tag itself functions properly. On the other hand, if the RFID tag is malfunctioning, no reading will be produced by the tag at all. A “blank” reading from the RFID tag will occur.

While the invention has been described with a limited number of embodiments, these specific embodiments are not intended to limit the scope of the invention as otherwise described and claimed herein. Variations and modifications therefrom exist, and they should be considered as equivalents to the current invention. For example, multiple end nodes can be “daisy chained” together by a single tentacle. Other communication models, such as network, point-to-point, point-to-multipoint, parallel/serial, relay, etc. can also used in the current invention.

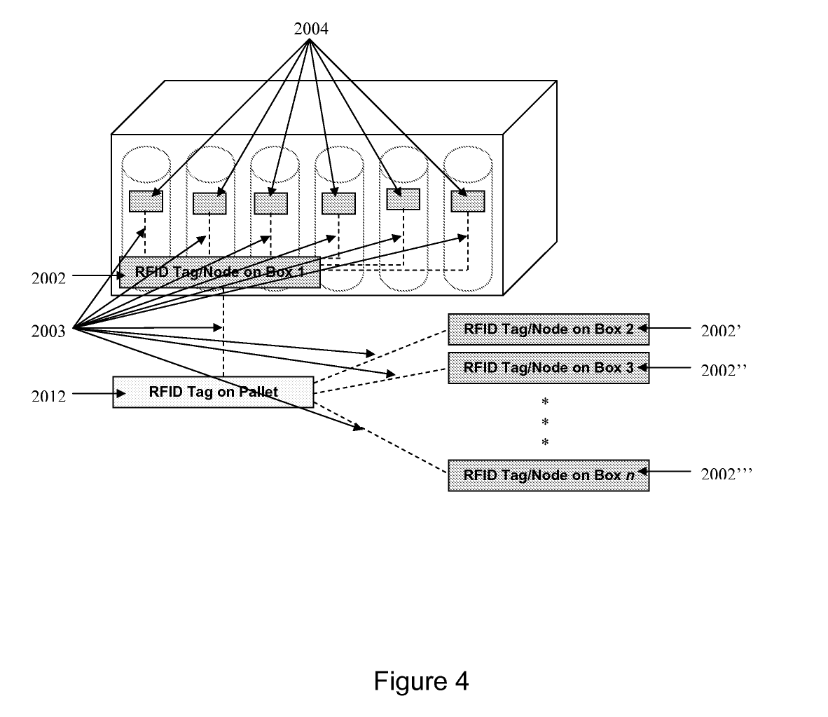

Further, the above described embodiments can also be expanded to configurations where a group of products or a group of packages need to be tracked/verified. For example, as shown in FIG. 4, when a group of products are packed into a box, one RFID tag 2002 is provided to read the status of nodes 2004, which are placed inside of the products and are connected to the RFID tag 2002 via tentacles 2003. Multiple boxes of products can be similarly monitored by RFID tags 2002′, 2002″ . . . 2002′″, respectively. All RFID tags (2002, 2002′, 2002″ . . . 2002′″) can be optionally connected to a pallet RFID tag 2012. Therefore, one reading of the pallet RFID tag 2012 could reveal item-level information for the entire pallet of items connected to the pallet tag 2012. A more efficient tracking and identifying method is achieved.

What is claimed is:

1. A system comprising:
a) a radio-frequency identification (RFID) tag;
b) an end node; and
c) a tentacle that electrically connects the RFID tag with the end node;
wherein the tentacle is electrically conductive so that the RFID tag is capable of electrically communicating with the end node via the tentacle.

2. The system of claim 1, wherein the RFID tag is a passive RFID tag.

3. The system of claim 1, wherein the RFID tag is an active RFID tag.

4. The system of claim 1, wherein the end node is a conductive device.

5. The system of claim 1, wherein the end node is a memory storage device.

6. The system of claim 1, wherein the end node is a chip.

7. The system of claim 1, wherein the end node is an RFID tag.

8. The system of claim 1, wherein the tentacle is made from an electrically conductive material.

9. The system of claim 1, wherein the tentacle is made from a material selected from the group consisting of copper, silver, gold, and mixtures thereof.

10. The system of claim 1, wherein the end node is capable of electronically communicating with the RFID tag by sending a variation to the RFID tag.

11. The system of claim 1, wherein the end node is capable of electronically communicating with the RFID tag via a data packet.

12. The system of claim 1, wherein the end node is capable of electronically communicating with the RFID tag by sending a data stored in the end node to the RFID tag.

13. A system comprising:
a) a radio-frequency identification (RFID) tag; and
b) a tentacle,
wherein the tentacle is electrically conductive and has two ends, both terminating on the RFID tag, therefore forming a closed electrical circuit with the RFID tag.
